(19) United States
(12) Patent Application Publication
(10) Pub. No.: US 2005/0201660 A1
(43) Pub. Date: Sep. 15, 2005

(54) Apparatus for single nanoparticle detection

(76) Inventors: Annette C. Grot, Loveland, CO (US); Laura Wills Mirkarimi, Loveland, CO (US); Mihail M. Sigalas, Loveland, CO (US); Kai Cheung Chow, Loveland, CO (US)

Correspondence Address: AGILENT TECHNOLOGIES, INC.;INTELLECTUAL PROPERTY ADMINISTRATION, LEGAL DEPT., P.O. BOX 7599, M/S DL429, LOVELAND, CO, 80537-0599, US

(21) Appl. No.: 11/078,785

(22) Filed: Mar. 11, 2005

Related U.S. Application Data
(63) Continuation-in-part of application No. 10/799,020, filed on Mar. 11, 2004.

(51) Int. Cl. G02B 6/00

(52) U.S. Cl. 385/12

(57) ABSTRACT

A photonic crystal sensor adapted for single nanoparticle detection is disclosed. Very small single particles and single molecules may be detected. The sensors may be adapted to allow differential measurements.

### CROSS-REFERENCE TO RELATED APPLICATIONS

This application is a continuation in part of U.S. patent application Ser. No. 10/799,020 FILED Mar. 11, 2004.

### BACKGROUND

Numerous chemical and biological sensors exist based on the optical, electrochemical, or physical properties of the analyte. Optical sensors typically provide non-destructive, high sensitivity detection and good discrimination between the analyte and the typical water background. Optical approaches include surface plasmon resonance, interferometry using two waveguide branches and refractive index measurements based on internal reflection. The optical signal detected is proportional to the refractive index averaged over the optical volume.

In some applications, it is desirable to restrict the volume for analysis to less than 1 fL to isolate one or more molecules even in high concentrations. Typically, the analysis volume for optical sensors is no smaller than the cube of the operational wavelength and may be much larger. Hence, for typical operational wavelengths of 0.5 μm to 1.5 μm the analysis volume exceeds 1 fL. For typical optical sensors the probing optical field decays exponentially and this can effect the responsivity of the optical sensor.

### SUMMARY OF THE INVENTION

In accordance with the invention, photonic crystal sensors may be made from two dimensional photonic crystal lattices by introduction of a lattice defect. These two dimensional photonic crystal structures allow the optical field to be confined to analyte volumes less than 1 fL with sensitivities extending to the detection of single molecules.

### BRIEF DESCRIPTION OF THE DRAWINGS

FIG. 1 shows an embodiment in accordance with the invention.

FIG. 2a shows transmittance/reflectance for TM polarization as a function of the angle of incidence.

FIG. 2b shows transmittance/reflectance for TE polarization as a function of the angle of incidence.

FIG. 2c shows the shift in wavelength as a function of refractive index for an embodiment in accordance with the invention.

FIG. 2d shows normalized transmission spectra as a function of wavelength for an embodiment in accordance with the invention.

FIG. 2e shows the shift in operating wavelength Δλ as a function of film thickness for an embodiment in accordance with the invention.

FIG. 2f shows the change in the operating wavelength/refractive index as a function of time for an embodiment in accordance with the invention.

FIG. 2g shows a dither system in an embodiment in accordance with the invention.

FIG. 2h shows a synchronized scanning system in an embodiment in accordance with the invention.

FIG. 2i shows a wide-band multiple element non-tunable source system in an embodiment in accordance with the invention.

FIG. 2j shows slope based peak detection system in an embodiment in accordance with the invention.

FIG. 3a shows an embodiment in accordance with the invention.

FIG. 3b shows an embodiment in accordance with the invention.

FIG. 3c shows an embodiment in accordance with the invention.

FIG. 3d shows an embodiment in accordance with the invention.

FIG. 3e shows an embodiment in accordance with the invention.

FIGS. 4a-b show an embodiment in accordance with the invention.

FIG. 5a shows an embodiment in accordance with the invention.

FIG. 5b shows a simplified view of an embodiment in accordance with the invention.

FIG. 5c show transmission versus frequency for the embodiment in FIG. 5 and the optical signal leaked out of the top of the plane of photonic crystal configuration.

FIG. 6a shows an embodiment in accordance with the invention.

FIG. 6b shows an embodiment of a diffractive supercell in accordance with the invention.

FIG. 7 shows an embodiment in accordance with the invention using a materials stack.

FIGS. 8a-c shows steps for making an embodiment in accordance with the invention.

FIG. 9 shows an embodiment in accordance with the invention.

FIG. 10 shows the out of plane field for an embodiment in accordance with the invention.

FIG. 11 shows a system for differential measurement on single nanoparticles in accordance with the invention.

### DETAILED DESCRIPTION

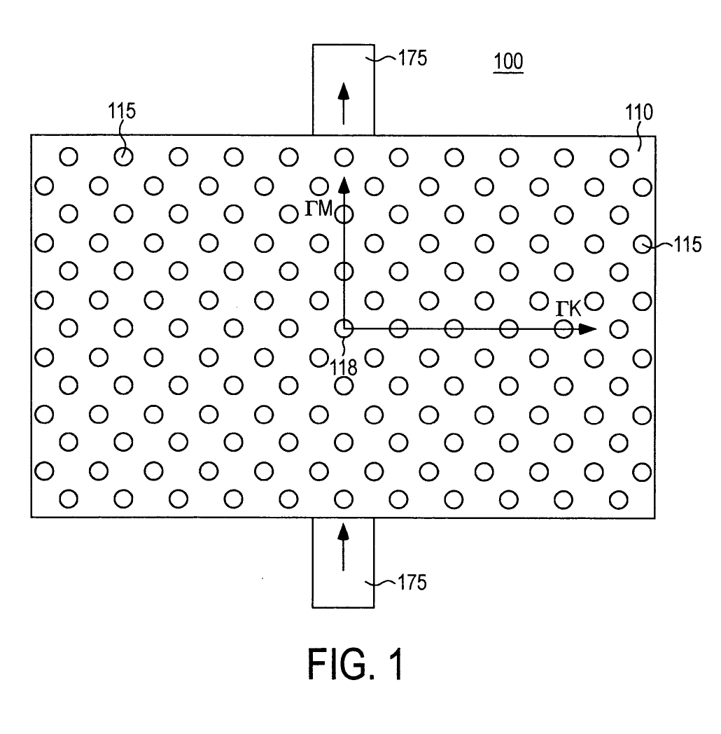

Photonic crystal structures allow optical fields to be tightly confined to volumes less than about 1 μm³. Photonic crystal structures are materials patterned with a periodicity in dielectric constant which can create a range of forbidden frequencies or wavelengths called a photonic bandgap. Photons with energies lying in the bandgap cannot propagate through the material. A photonic crystal sensor can be created in a two or three dimensional photonic crystal lattice by introducing a defect into the photonic crystal lattice structure. The term “photonic crystal sensor” for the purposes of this patent application is defined to be an optical sensor that uses a photonic crystal to localize the optical field or light in a volume having an average dielectric susceptibility lower than that of the surrounding material. Such a volume is the defect hole in a two dimensional photonic crystal sensor, for example (see FIG. 1). Photonic crystal sensors as defined in this application are distinguished from optical micro-cavity sensors (e.g. see U.S. Pat. No. 6,661,938, col. 3, lines 26-38). For optical micro-cavity sensors, increases in sensitivity require increases in the Q factor. As explained below, this is not the case for photonic crystal sensors.

A two dimensional photonic crystal lattice in accordance with the invention may be constructed by etching holes of the same radius into a high index material slab made from, for example, Si, or InP where the defect is a hole having a different radius from the rest of the holes. Optical confinement in the third dimension is provided by using low index cladding layers, typically oxide films such as SiO₂ or air, above and below the high index slab. To create wide photonic gaps, the radius of the holes is typically in the range from about 0.2a to 0.4a where a is the lattice constant. Lattice structures having hexagonal symmetry typically produce the largest bandgap.

In accordance with the invention, a three dimensional photonic crystal lattice may be constructed from layers of dielectric rods having a high refractive index. Optical confinement is then provided by photonic bandgaps in all three dimensions.

In an embodiment in accordance with the invention, with reference to FIG. 1, photonic crystal sensor 100 may be constructed using two dimensional photonic crystal lattice structure 110. The operating frequency of photonic crystal sensor 100 decreases as the effective or average refractive index of the material inside holes 115 and hole 118 increases. Photonic crystal lattice structure 110 can be constructed to have a bandgap between about 1300 nm and 1600 nm by etching holes 115 with a diameter of about 255 nm (0.58a) on a triangular lattice having a lattice constant a of about 440 nm in a Si slab material about 260 nm (0.59a) thick. Reducing the diameter of defect hole 118 from about 255 nm (0.58a) to about 176 nm (0.40a) results in photonic crystal sensor 100.

If holes 115 and defect hole 118 are filled with air at a refractive index of about 1.00, the operating wavelength is about 1350 nm. The “operating wavelength” or “operating frequency” for the purposes of this patent application is defined to be the wavelength or frequency at which the optical field or light is localized. If photonic crystal sensor 100 is coated with a thin conformal film typically having a refractive index of about 1.5 and thickness of about 10 nm, the average index of refraction inside holes 115 and defect hole 118 is typically increased to shift the operating wavelength to about 1360 nm. Most typical thin films of interest are conformal. Conformality can be encouraged for water based solution analysis by insuring the surface of photonic crystal sensor 100 is hydrophilic. For protein analysis, a polyelectrolyte thin film deposition technique may be used to prepare a continuous, conformal coating of poly-d-lysine which enhances the bonding of proteins to the surface. However, the thin film need not be conformal as long as film material enters holes 115 and defect hole 118. Typically, the shift in operating wavelength depends on the radii of holes 115 and the radius of defect hole 118. Software packages such as MIT Photonic Bands (MPB) package available from the Massachusetts Institute of Technology may be used to predict the operating wavelength. Note that all holes 115 and defect hole 118 have a depth corresponding to the thickness of the slab material, in this example, about 260 nm.

In accordance with an embodiment of the invention, two conventional ridge waveguides 175 about 0.75 mm long are used to couple light in and out of photonic crystal sensor 100 and are attached to photonic crystal lattice structure 110 in a direction perpendicular to the direction typically used for waveguide propagation in photonic crystal lattice structure 110. Conventional ridge waveguides 175 are tapered down from a about 2 μm width to a width of about 1.4a which is about 0.6 μm to match the mode profile as shown in FIG. 1. The external facets of conventional ridge waveguides 175 are typically antireflection coated with a pair of TiO₂ and SiO₂ layers to suppress the Fabry-Perot resonance. The use of antireflection coating may be avoided by using a waveguide taper to expand the optical mode into a low-refractive index (typically about 1.5) waveguide that does not have high reflectivity at the air interface. The two distinct directions on photonic crystal lattice structure 110 are the nearest neighbor direction (ΓK) and the second nearest neighbor direction (ΓM). Between conventional ridge waveguides 175, photonic crystal sensor 100 typically has six layers of photonic crystal along the ΓM direction and typically eleven to twelve layers along the perpendicular ΓK direction. In accordance with an embodiment of the invention, light is coupled into photonic crystal sensor 100 along the ΓM direction because the coupling efficiency along the ΓM direction is typically at least a factor four higher than the ΓK direction. The difference in coupling efficiency arises because the in-plane leakage from the finite size effect in these kinds of dipole modes lies mainly along the ΓM direction.

The transmission spectrum is typically measured using a tunable narrowband optical source coupled to photonic crystal lattice structure 110 using free space or waveguide optics. For example, a tunable TE polarized laser beam may be focused into conventional ridge waveguide 175 using, for example, a microscope objective lens. Conventional ridge waveguide 175 has a numerical aperture (NA) or acceptance angle associated with it. As long as the NA of the converging laser beam coming from the microscope objective lens is less than the NA of conventional ridge waveguide 175, the light is coupled into conventional ridge waveguide 175. The NA of conventional ridge waveguide 175 is related to the refractive index difference between the waveguide core, n₁ and the waveguide cladding, n₂: NA=(n₁²−n₂²)^{1/2}. The larger the refractive index of the waveguide core compared to the refractive index of the waveguide cladding, the greater NA or acceptance angle.

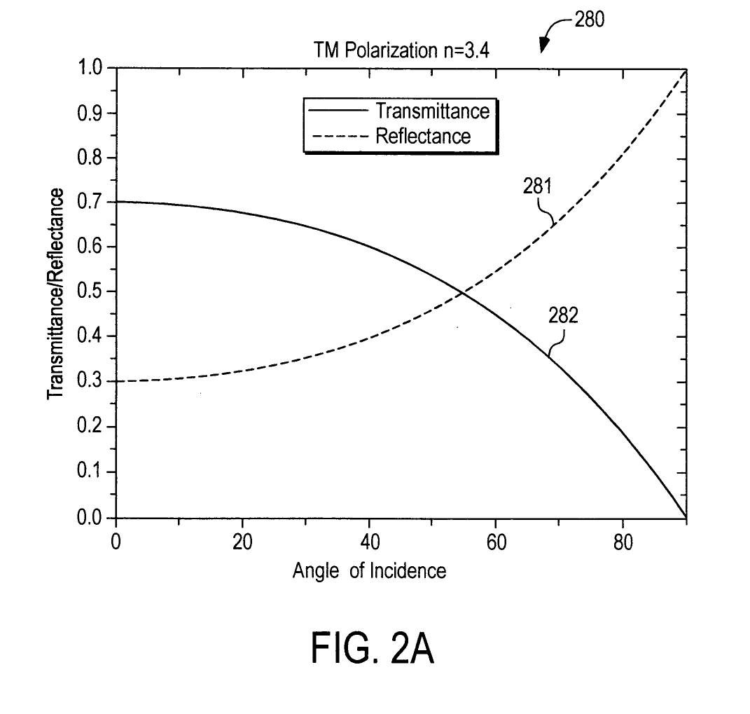

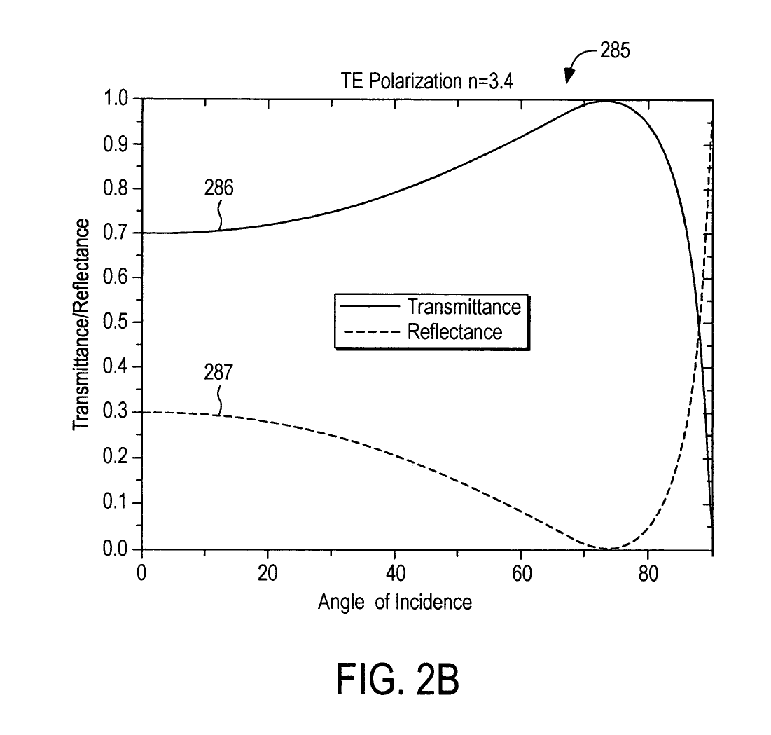

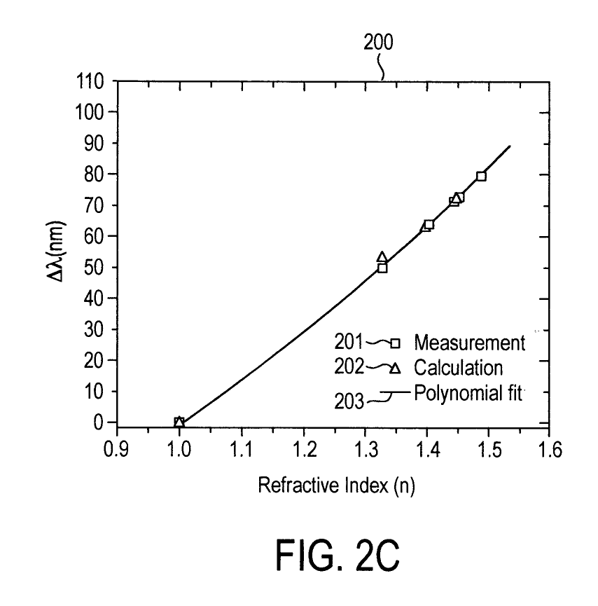

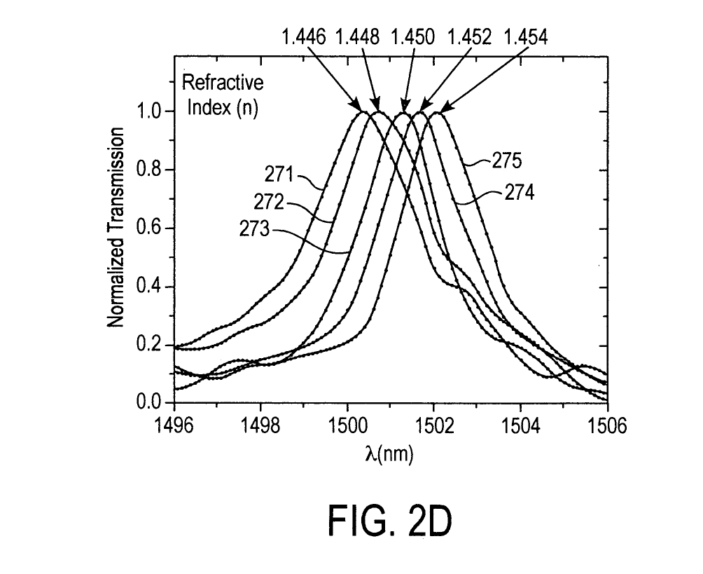

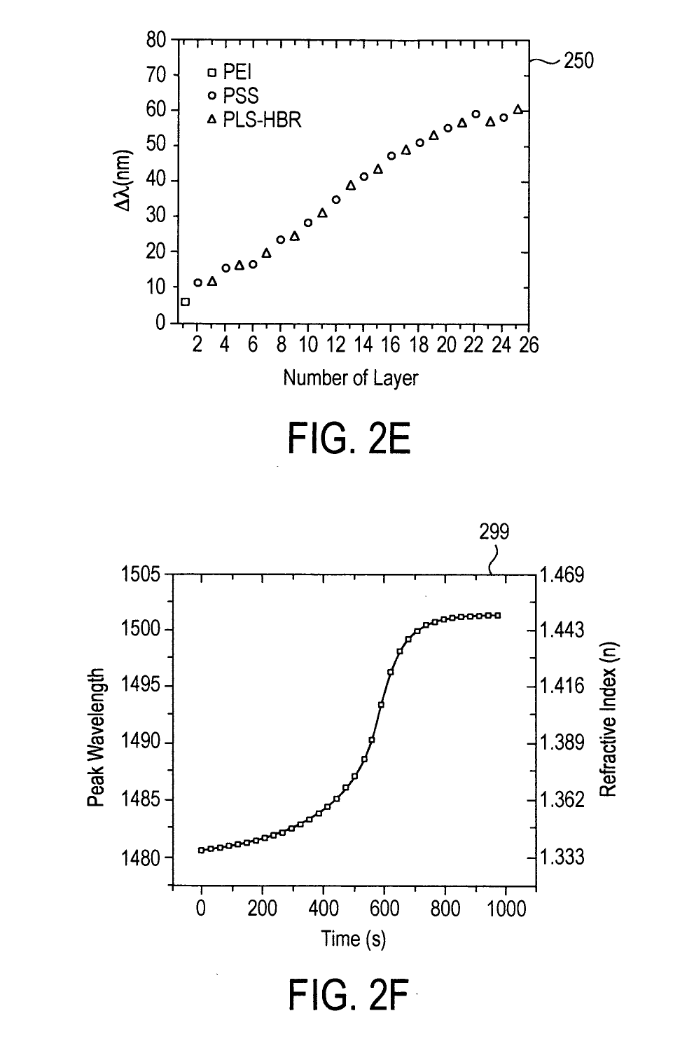

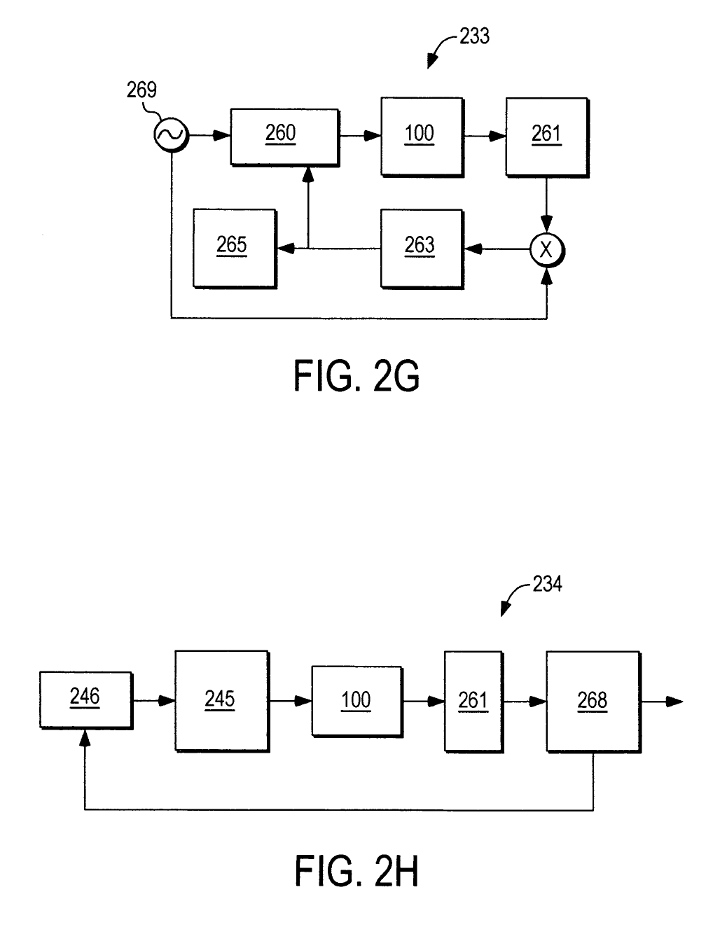

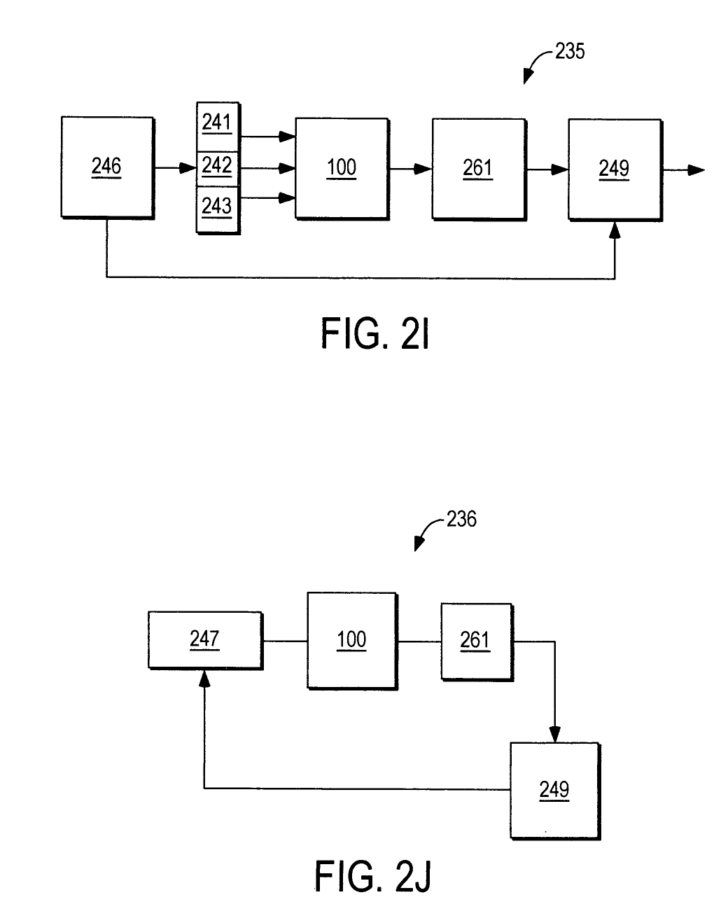

For example, if n₁˜3.4 and n₂˜1.5, the acceptance angle is effectively 90 degrees and the reflectance/transmittance as a function of angle of incidence needs to be considered. FIG. 2a shows graph 280 where curve 281 shows the reflectance as a function of the angle of incidence while curve 282 shows the transmittance as a function of the angle of incidence for a TM polarized wave. FIG. 2b shows graph 285 where curve 287 shows the reflectance as a function of the angle of incidence while curve 286 shows the transmittance as a function of the angle of incidence for a TE polarized wave. All wave polarizations may be represented as a linear combination of TE and TM polarizations. For photonic crystal sensor 100 only the TE polarized wave has the photonic bandgap.

A spectrometer or monochromator illuminated by a broadband optical source may also be used to measure the transmission spectrum. Transmitted power exiting conventional ridge waveguide 175 is typically measured using a calibrated InGaAs detector or other suitable photodetector (not shown). An infrared camera may be used as a diagnostic to monitor the mode profile of the transmitted light to ensure that only the signal from the waveguide mode enters the photodetector. When the optical wavelength of the narrowband optical source matches the operating wavelength of photonic crystal sensor 100, maximum optical power is transmitted through photonic crystal sensor 100. Curve fitting can be employed to improve the sensitivity to determine the operating frequency or wavelength of photonic crystal sensor 100.

In accordance with an embodiment of the invention with reference to FIG. 2g, in dither system 233, narrowband optical source 260 is optically coupled to photonic crystal sensor 100. The optical frequency of narrowband optical source 260 may be modulated by applying a slowly varying sinusoidal signal from signal generator 269 and causing the optical frequency or wavelength to slowly vary (sometimes referred to as “dithering”). Narrowband optical light source 260 is typically selected to be a semiconductor laser which may be modulated by applying a small modulation to the injection current. When the optical frequency or wavelength of narrowband optical light source 260 is close to the center frequency or wavelength of the operating wavelength or frequency, the voltage from photodetector 261 in response to the slowly varying optical frequency or wavelength is also modulated. The amplitude of the voltage from photodetector 261 is related to how far from the operating frequency or wavelength the slowly varying optical frequency or wavelength is. Typically, a device such as lock-in amplifier 263, for example, may be used to produce an error signal that goes to narrowband optical light source 260 and processor 265. The error signal allows locking to the peak of the operating frequency using a feedback loop because the amplitude of the dither signal on photodetector 261 is a minimum when the optical frequency of narrowband optical source 260 is at the operating frequency or wavelength of photonic crystal sensor 100. Hence, the operating frequency or wavelength of photonic crystal sensor 100 may be determined in processor 265.

In accordance with an embodiment of the invention with reference to FIG. 2h, synchronized scanning system 234 may be used to determine the operating frequency or wavelength. By measuring the photocurrent from photodetector 261 as a function of time and synchronizing to time varying tunable narrowband optical source 245 such as tunable laser, the operating frequency or wavelength can be encoded as a time delay, δ. For example, if the tunable narrowband optical source 245 coupled to photonic crystal sensor 100 is uniformly tuned by to scan from 1490 nm to 1510 nm in about 20 msec and a pulse is delivered by clock 246 to peak capture circuit 268 at the beginning of the scan, determination of when in time the peak current occurs allows determination of the operating frequency or wavelength. If, for example, the peak current occurs 10 msec after the pulse indicating the start of the wavelength scan is delivered to the peak capture circuit 268, the operating wavelength is at 1500 nm.

In accordance with an embodiment of the invention with reference to FIG. 2i, wide-band multiple element non-tunable source system 235 uses relatively broad non-tunable optical sources such as light emitting diodes (LEDs) may be used at comparatively low cost. For example, three LEDs 241, 242, 243 each having a full width half maximum (FWHM) spectral width of about 40 nm centered at different wavelengths 1480 nm, 1500 nm and 1520 nm, respectively, may be used. Each of the LEDs 241, 242, 243 is turned on in sequence by clock 246 and optically coupled to photonic crystal sensor 100. Photodetector 261 measures the transmitted power from each LED 241, 242, 243 in sequence. The current generated by photodetector 261 is governed by the convolution of the LED's power distribution and the transmission curve for photonic crystal 100. The use of three LEDs 241, 242, 243 removes the wavelength or frequency ambiguity that is present when the operating wavelength or frequency is not matched to peak frequency of the optical source and increases the dynamic range of the system. The larger the frequency spread of the optical source the more operating frequencies may be addressed which allows a wider range of film thicknesses up to the size of defect hole 118. If the FWHM of the LEDs is about 40 nm and the FWHM of the sensor spectral profile is about 2 nm, adequate wavelength discrimination is obtained.

In accordance with an embodiment of the invention with reference to FIG. 2j, slope based peak detection system 236 uses tunable narrowband optical source 247 optically coupled to photonic crystal sensor 100 is used where the frequency or wavelength of tunable narrowband optical source 247 switches at a frequency f₀ between two optical wavelengths. The difference between the two optical wavelengths is kept constant by the electronics in tunable narrowband optical source 247 and tunable narrowband optical source 247 is operating in “dither” mode. Photodetector 261 measures the relative power transmitted at the two different wavelengths and an error signal from bandpass filter 249 centered at f₀ tunes the lower frequency or wavelength such that the current from photodetector 261 is equal for both wavelengths. The operating wavelength is then at the midpoint between the lower and upper wavelength.

A droplet of calibrated commercial silicone fluid is applied by syringe to the surface of photonic crystal sensor 100 typically resulting in a film thickness over the surface of photonic crystal sensor 100 on the order of a few hundred μm and an area coverage of about 5 mm². Because the volume of the silicone fluid on the surface of photonic crystal sensor 100 is several orders of magnitude larger than the sensing volume, the silicone fluid may be taken to be an infinite homogeneous background replacing the air. Photonic crystal sensor 100 is rinsed in acetone and isopropanol then dried before application of the next drop of silicone fluid having a different refractive index.

Graph 200 in FIG. 2c shows the shift in operating wavelength Δλ=λ(n)−λ(air) as a function of ambient refractive index n in holes 115 and hole 118 for the embodiment in accordance with the invention shown in FIG. 1. Quadratic fit 203 is applied to both measured data 201 and calculated data 202. The close agreement between calculated data 202 and measured data 201 indicates that the silicone fluid has completely filled holes 115 and 118.

FIG. 2d shows normalized transmission spectra 271, 272, 273, 274, 275 obtained using five different indices of refraction from about n=1.446 to n=1.454, respectively, with increments Δn=0.002. The operating wavelength in FIG. 2d increases by about 0.4 nm for a refractive index increase of Δn=0.002. The transmission data are numerically smoothed to remove the Fabry-Perot oscillations due to residual reflectivity at the end facets of conventional ridge waveguides 175. The operating peak wavelength is determined by fitting data to a Lorentzian. Transmission spectra 271, 272, 273, 274, 275 were obtained by successive application of droplets of commercial silicone fluid to the surface of photonic crystal sensor 100. The commercial silicone fluids used have a calibrated refractive index accuracy of Δn =±0.0002 and refractive index increments of Δn=0.002.

Graph 250 in FIG. 2e shows the shift in operating wavelength Δλ as a function of film thickness for an embodiment in accordance with the invention. Graph 250 shows the operating wavelength shift using exemplary materials that are of similar refractive index to proteins and antibodies (refractive index n in the range from about 1.4 to 1.5). Layer by layer electrostatic assembly of electrically charged polymers is performed using, polyetheleneimine (PEI), polysodium 4-styrenesulfate (PSS) and poly (d-lysine hydrobromide) (PLS-HBR). The thin film layers are each typically in the range of 2-3 nm thick. The effective charge on PEI and PLS-HBR is positive while the effective charge on PSS is negative. PEI typically functions well as a surface preparation chemical because it readily attaches to an SiO₂ surface. PSS and PLS-HBR are weak electrolytes that deposit as smooth, uniform monolayers.

Photonic crystal sensor 100 may be used to measure the thickness of thin films where the film thickness is less than the radius of hole 118. Once defect hole 118 and holes 115 are filled, the operating wavelength or frequency will not shift because the optical field or light is confined within the plane of photonic crystal sensor 100. If defect hole 118 is filled prior to holes 115 a shift in operating wavelength or frequency still occurs. In typical operation, defect hole 118 is not completely filled.

Photonic crystal sensor 100 may also function to perform time resolved in-situ sensing. As an example, a droplet of 5 percent glycerol in deionized water having a volume on the order of the silicone fluid droplet discussed above is applied to the surface of photonic crystal sensor 100. Photonic crystal sensor 100 is then heated resulting in the evaporation of the deionized water. Graph 299 in FIG. 2f shows the change in the operating wavelength as a function of time where the right vertical axis shows the corresponding refractive index n obtained using the quadratic fit from FIG. 2a. As the deionized water evaporates, the operating wavelength shifts from about 1480.82 nm to about 1501.45 nm corresponding to a refractive index change from about n=1.338 to n=1.451. The initial and final refractive index correspond to 5 percent and 85 percent glycerol, respectively, in the glycerol deionized water mixture. The glycerol deionized water mixture reaches a steady state after about 900 seconds.

A source of noise for photonic crystal sensor 100 involves variations of temperature. For example, the refractive index of water depends on the water temperature. For temperatures in the range of about 20° C. to 50° C., the refractive index dependence for water on temperature is dn/dT≈3×10⁻⁴ at about 1500 nm. Hence, a 1° C. change in temperature results in a refractive index change of about 3×10⁻⁴ and the change in operating frequency or wavelength for photonic crystal sensor 100 is about 0.06 nm.

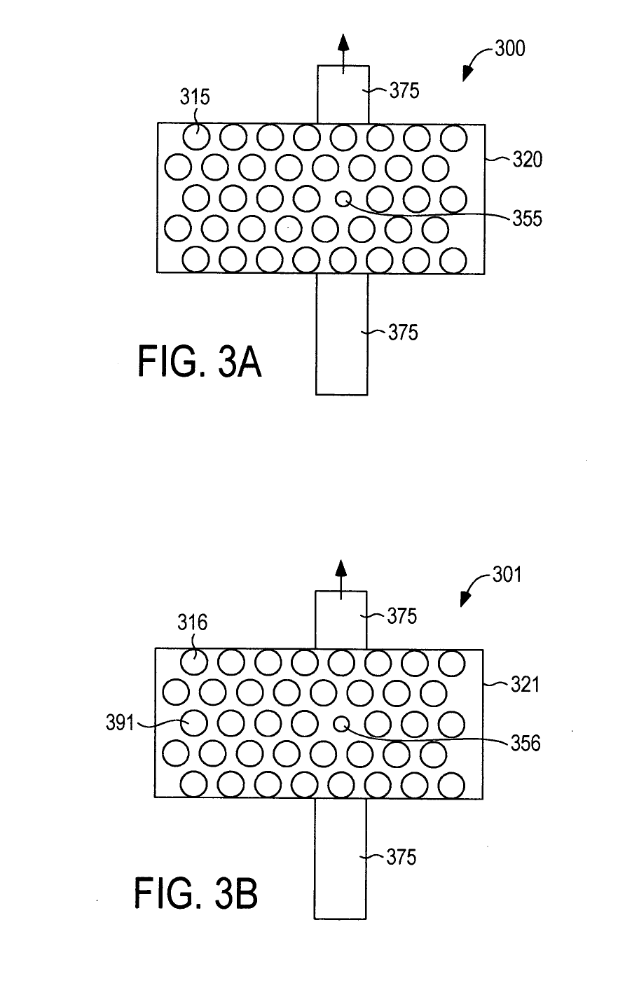

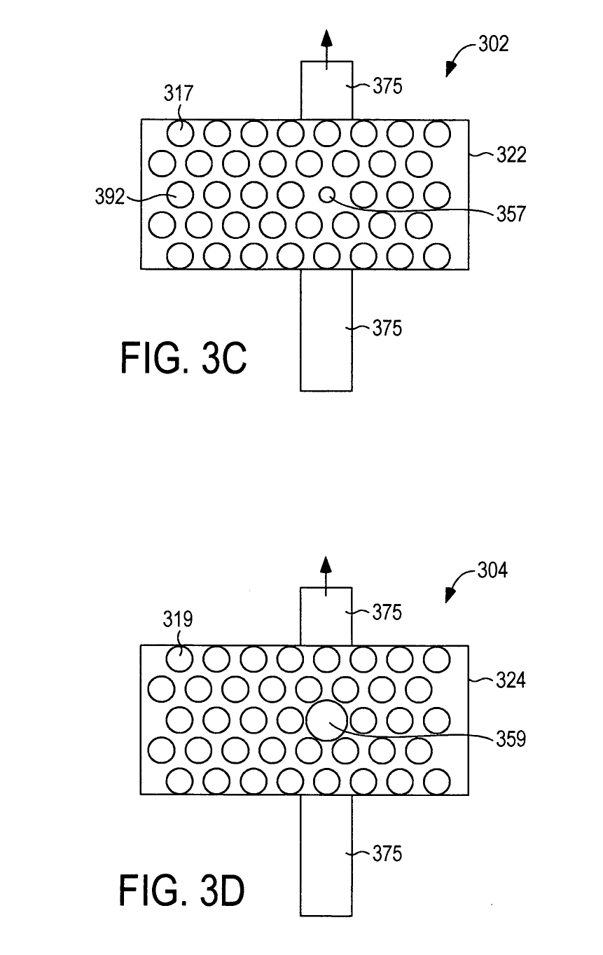

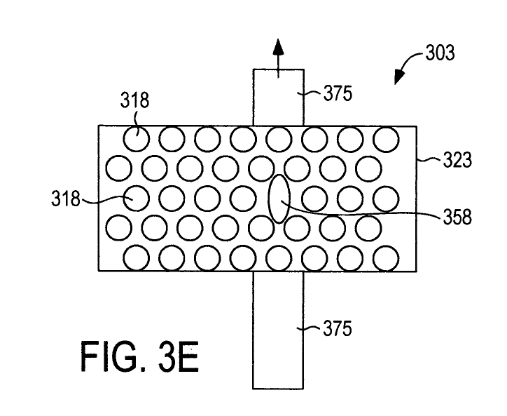

Variations of photonic crystal sensor 100 in FIG. 1 may be constructed that have varying degrees of sensitivity. FIGS. 3a-e show variations of photonic crystal sensor 100 shown in FIG. 1. 300, 301, 302, 303, 304 use high refractive index slabs 320, 321, 322, 323, 324, respectively, having a refractive index n of about 3.4 corresponding to materials such as Si or GaAs and a thickness of about 0.6a where a is the lattice constant. Slabs 320, 321, 322, 323, 324 are each placed over a low refractive index material having a refractive index of about 1.4 corresponding to materials such as SiO₂. Five layers of holes 315, 316, 317, 318, 319 corresponding to slabs 320, 321, 322, 323, 324, respectively, are positioned along the propagation direction and used in photonic crystal sensors 300, 301, 302, 303, 304. Conventional ridge waveguides 375 having a width 1.4a are used to couple light into and out of photonic crystal sensors 300, 301, 302, 303, 304. Holes 315, 316, 317, 318, 319 are made in high refractive index slabs 320, 321, 322, 323, 324, respectively, on a triangular lattice with lattice constant a. Holes 315, 316, 317, 318, 319 are taken to be air filled or filled with a low index refractive material having a refractive index of about 1.4. The area above high refractive index slabs 320, 321, 322, 323, 324 is either air or a low refractive index material having a refractive index of about 1.4 The change in operating frequency Δν for photnic crystal sensors 300, 301, 302, 303, 304 divided by the operating frequency in air νₐᵢᵣ provides a measure of the sensitivity of photonic crystal sensors 300, 301, 302, 303, 304. The greater Δν/νₐᵢᵣ, the higher the sensitivity of the particular photonic crystal sensor resulting in a better sensor.

FIG. 3a shows photonic crystal sensor 300 where holes 315 have a radius of about 0.29a in an embodiment in accordance with the invention or in an alternative embodiment in accordance with the invention, a radius of about 0.36a where a is the lattice spacing. Hole 355 has a radius of about 0.17a when holes 315 have a radius of about 0.29a and a radius of about 0.21 a when holes 315 have a radius of about 0.36a. For photonic crystal sensor 300 this results in Δν/νₐᵢᵣ=0.044 for the sensitivity measure when holes 315 have a radius of about 0.29a and in Δν/νₐᵢᵣ=0.065 for the sensitivity measure when holes 315 have a radius of about 0.36a.

FIG. 3b shows photonic crystal sensor 301 where holes 316 have a radius of about 0.29a in an embodiment in accordance with the invention or in an alternative embodiment in accordance with the invention holes 316 have a radius of about 0.36a. Holes 391 of the middle layer and hole 356 are elongated in the propagation direction by about 0.125a which results in elliptical holes 391 having a major axis of about 0.705a or 0.845a corresponding to holes 316 having a radius of about 0.29a or 0.36a, respectively. Elliptical hole 356 has a major axis of about 0.465a when holes 316 have a radius of about 0.29a and a major axis of about 0.545 when holes 316 have a radius of about 0.36a. For photonic crystal sensor 310 this results in Δν/νₐᵢᵣ=0.038 for the sensitivity measure when holes 316 have a radius of about 0.29a and in Δν/νₐᵢᵣ=0.056 when holes 316 have a radius of about 0.36a.

FIG. 3c shows photonic crystal sensor 302 where holes 317 have a radius of about 0.29a in an embodiment in accordance with the invention or in an alternative embodiment in accordance with the invention, holes 317 have a radius of about 0.36a. Holes 392 of the middle layer and hole 357 are elongated in the propagation direction by about 0.125a which results in elliptical holes 392 having a major axis of about 0.705a or 0.845a corresponding to holes 317 having a radius of about 0.29a or 0.36a, respectively. Elliptical hole 357 has a major axis of about 0.525a when holes 317 have a radius of about 0.29a and a major axis of about 0.625a when holes 317 have a radius of about 0.36a. For photonic crystal sensor 302 this results in Δν/νₐᵢᵣ=0.044 for the sensitivity measure when holes 317 have a radius of about 0.29a and in Δν/νₐᵢᵣ=0.063 when holes 317 have a radius of about 0.36a.

FIG. 3d shows photonic crystal sensor 304 where holes 319 have a radius of about 0.29a in an embodiment in accordance with the invention or in alternative embodiment in accordance with the invention, holes 319 have a radius of about 0.36a. Circular hole 359 has a radius of about 0.57a. For photonic crystal sensor 304 this results in Δν/νₐᵢᵣ=0.045 for the sensitivity measure when holes 319 have a radius of about 0.29a and Δν/νₐᵢᵣ=0.073 for the sensitivity measure when holes 319 have a radius of about 0.36a.

FIG. 3e shows photonic crystal sensor 303 where holes 318 have a radius of about 0.29a in an embodiment in accordance with the invention or in an alternative embodiment in accordance with the invention, holes 318 have a radius of about 0.36a. Elliptical hole 358 has a minor axis of about 0.66a and a major axis of about 1.48a. For photonic crystal sensor 303 this results in Δν/νₐᵢᵣ=0.051 for the sensitivity measure when holes 318 have a radius of about 0.29a and in Δν/νₐᵢᵣ=0.077 when holes 318 have a radius of about 0.36a. Hence, photonic crystal sensor 303 has the highest sensitivity to refractive index change but photonic crystal sensors 301 and 302 have higher Q factors due to greater localization of the optical field in the high refractive index material which acts to reduce sensitivity.

Transmission for photonic crystal sensors 300-304 is lower for the case where holes 315, 316, 317, 318, 319 have a radius of about 0.36a compared to about 0.29a and is due to reduced coupling between conventional ridge waveguides 375 and high refractive index slabs 320, 321, 322, 323, 324. For example, photonic crystal sensor 303 has a transmission of 0.31 with holes 318 having a radius of about 0.29a compared to a transmission of 0.11 with holes 318 having a radius of about 0.36a. The average dielectric constant of high refractive index slabs 320, 321, 322, 323 is smaller when the radius of holes 315, 316, 317, 318, 319 is about 0.36a compared to about 0.29a. Hence, the refractive index discontinuity between high refractive index slabs 320, 321, 322, 323, 324 and conventional ridge waveguides 375 is increased leading to reduced coupling. Coupling may be improved by tapering conventional waveguides 375 as described above. Sensitivity may be enhanced by placing metal layers above and below high refractive index slabs 320, 321, 322, 323, 324 to increase optical confinement. Metals such as gold, silver or aluminum may be used as they are less absorbing. The thickness of metal layers is typically on the order of the lattice constant a or less. For details see U.S. Patent Publication No. 20020159126A1 incorporated by reference. Because the metal layers act to confine the light in the direction perpendicular to the two dimensional photonic crystal slab, materials other than Si such as Al₂O₃, GaN, SiN or SiO₂ may be used. This increases the sensitivity of the photonic crystal sensors such as photonic crystal sensor 303. However, the optical absorption (especially at visible and near infrared wavelengths) by metals typically decreases the transmission and Q factor for such photonic crystal sensors.

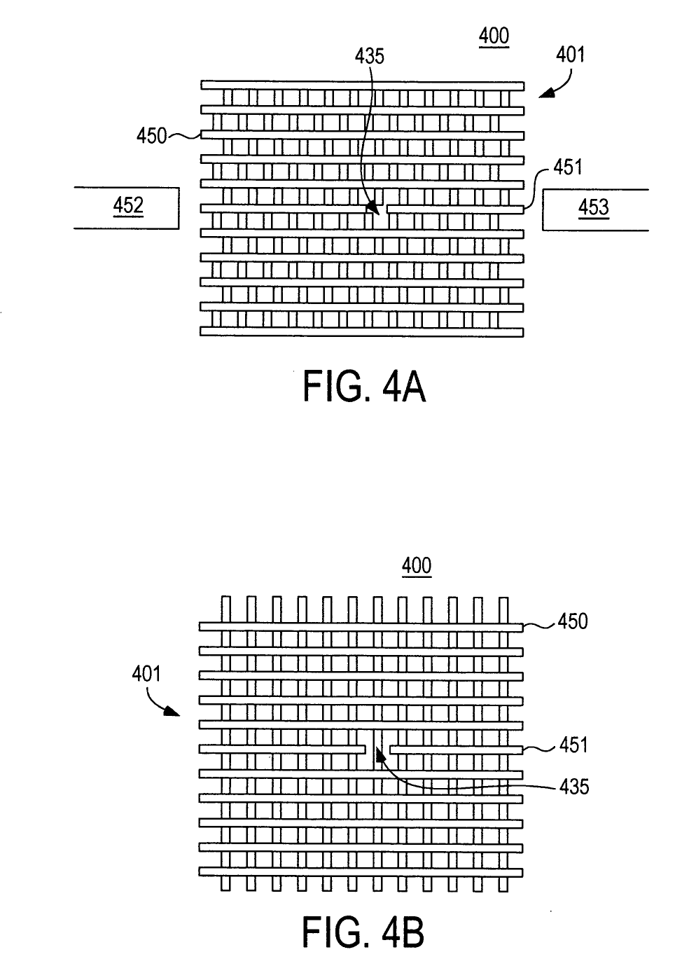

FIGS. 4a-4b show three dimensional photonic crystal sensor 400 in a side and top view, respectively, in accordance with the invention. Photonic crystal sensor 400 has 21 layers. Because photonic crystal sensor 400 is three dimensional, the peak in transmission due to defect region 435 appears for any incident angle of light. Hence, light may be coupled into photonic crystal sensor 400 from one side and outcoupled on the opposite side at the operating wavelength using, for example, conventional ridge waveguides 452 and 453, respectively. If light is to be coupled in perpendicular to the layers of three dimensional photonic crystal lattice 401 optical fiber waveguides are typically used. Three dimensional photonic crystal sensor 400 provides better sensitivity than photonic crystal sensors 300, 301, 302, 303, 304 but is typically more difficult to make. In an embodiment in accordance with the invention, three dimensional photonic crystal sensor 400 is constructed from layers of dielectric rods 450 having a refractive index of about 3.6 to form three dimensional photonic crystal lattice 401 and is typically Si, GaAs or InP. Dielectric rods 450, for example, have cross-sectional dimensions of about 0.22c by 0.25c where c is the thickness of one unit cell along the stacking direction and is equal to the thickness of four dielectric rods 450. Dielectric rods 450 are separated from each other by about 0.6875a within each layer. Defect region 435 is created by removing about 0.625a of the middle portion of rod 451. The sensitivity measure for photonic crystal sensor 400, Δν/νₐᵢᵣ=0.112.

In practice, the sensing volume that lies in defect region 435 of photonic crystal sensor 400 is lithographically defined. Because the optical field or light is localized in defect region 435, it is important to only have the volume around defect available for filling with the analyte. Replacement of the air with, for example, SiO₂ simplifies operation and fabrication while maintaining the performance of photonic crystal sensor 400, see Fleming, J. G. and Lin, S. Y. in Journal of Lightwave Technology, v17(11), p. 1956-1962, 1999, incorporated by reference. After completion of the three-dimensional layers of photonic crystal sensor 400, an opening in the photoresist is registered to defect region 435 of photonic crystal sensor 400. The use of a hydrofluoric acid etch or other selective etch that etches SiO₂ allows the removal of SiO₂ in the sensing volume. This enables the controlled flow of analyte into a small, well defined volume of photonic crystal 400 and requires less analyte.

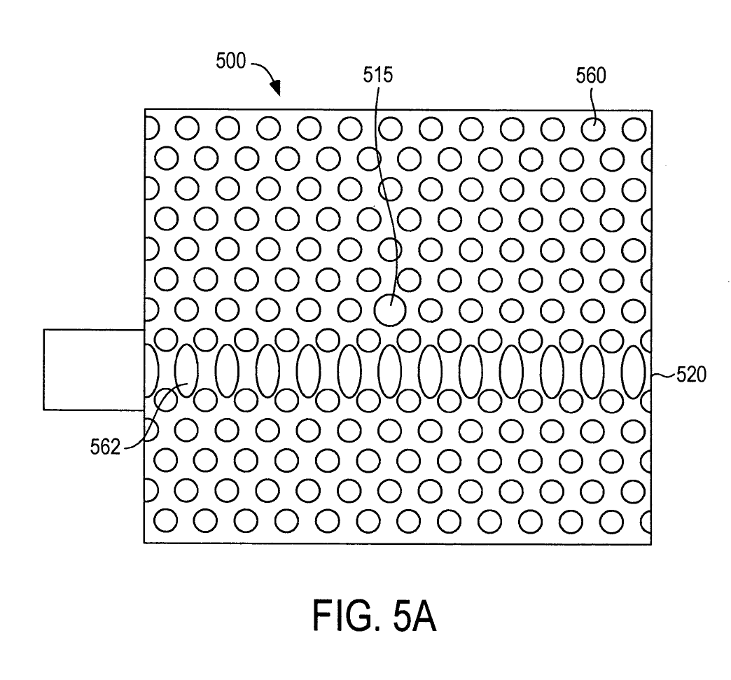

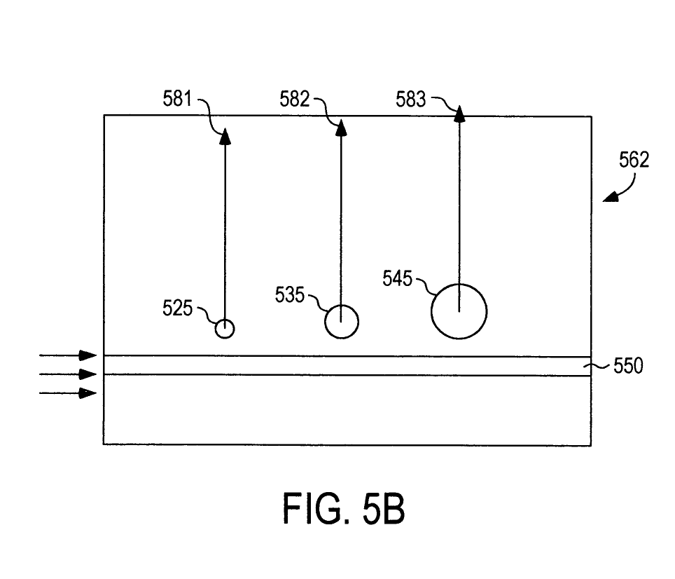

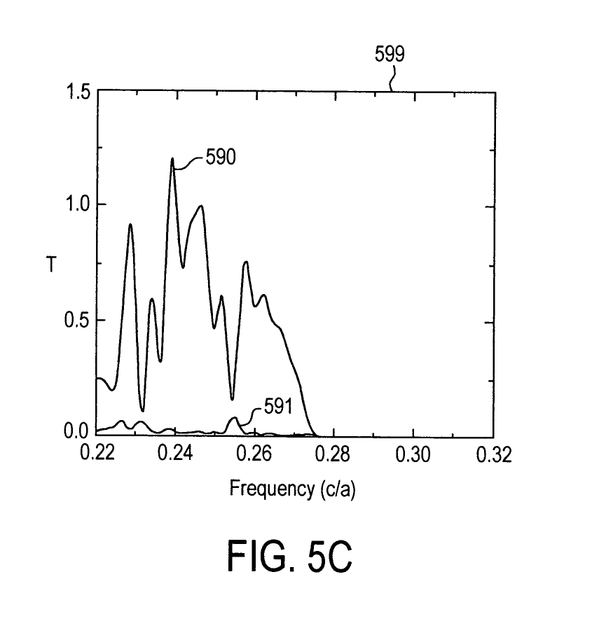

In accordance with embodiments of the invention, two dimensional photonic crystal sensors may be arranged in photonic crystal configuration 500 as shown in FIG. 5a to allow addressing of multiple defect holes as shown in FIG. 5b. Defect hole 515 can couple light out of photonic crystal waveguide 520. At the operating wavelength of defect hole 515, transmission along photonic crystal waveguide 520 drops as light is coupled out of photonic crystal waveguide 520 and a peak occurs for power passing out of the top of the plane of photonic crystal configuration 500. Changing the size and/or shape of defect hole 515 changes the operating wavelength. A series of defect holes 525, 535, 545 may be arranged along the length of photonic crystal waveguide 550 as shown in a conceptual view in FIG. 5b. Signal peaks 581, 582, 583 occur for signal leakage out of the plane of photonic crystal waveguide 575 at the different operating wavelengths of defect holes 525, 535, 545 as a tunable optical source (not shown) sweeps across a waveband. Signal peaks 581, 582, 583 (see FIG. 5b) are typically measured using photodetectors (not shown) positioned above defect holes 525, 535, 545, respectively. Microlenses (not shown) are typically used to focus the signal onto each photodetector.

With respect to FIG. 5a, for example, in an embodiment in accordance with the invention, holes 560 of photonic crystal configuration 500 have a radius of about 0.29a where a is the lattice constant and a depth of 0.6a in silicon slab 561 which is disposed on an SiO₂ substrate. One row of holes 560 is replaced by elliptical holes 562 having a minor axis of about 0.66a and a major axis of about 1.48a. Defect hole 515 has a radius of about 0.41 a. FIG. 5c shows graph 599 of transmission versus frequency along photonic crystal waveguide 520 and the optical signal leaked out of the top of the plane of photonic crystal configuration 500. At the operating frequency of defect hole 515, 0.254c/a where c is the speed of light in vacuum, there is an about 8 dB drop in the transmission along photonic crystal waveguide 520 indicated by line 590 and a peak in power leaking out of the plane indicated by line 591. About 8% of the leakage is into the SiO₂ substrate below and about 7% of the leakage is up out of the plane into the air.

With respect to FIG. 5b, the ordering of defect holes 525, 535, 545 is typically arranged such that the defect holes that couple more strongly to photonic crystal waveguide 520 are positioned further down photonic crystal waveguide 520 where the transmitted signal is weaker. This is because output efficiency depends on the ratio of the in-plane quality factor and perpendicular to the plane quality factor. The output efficiency is maximum when the ratio is unity. The quality factors depend on both the shape and size of defect holes 525, 535, 545, the separation between defect holes 525, 535, 545 and photonic crystal waveguide 550, the thickness of photonic crystal slab 562 and the refractive indices of photonic crystal slab 562 and the substrate (not shown in FIG. 5b). Because photonic crystal waveguide 550 is lossy, those defect holes of defect holes 525, 535, 545 with low output efficiency are positioned near the input to photonic crystal waveguide 550 and those defect holes of defect holes 525, 535, 545 with high output efficiency are positioned near the end of photonic crystal waveguide 550. Details regarding the output efficiency may be found in M. Imada et al, Journal of Lightwave Technology 20, 873, 2002 which is hereby incorporated by reference.

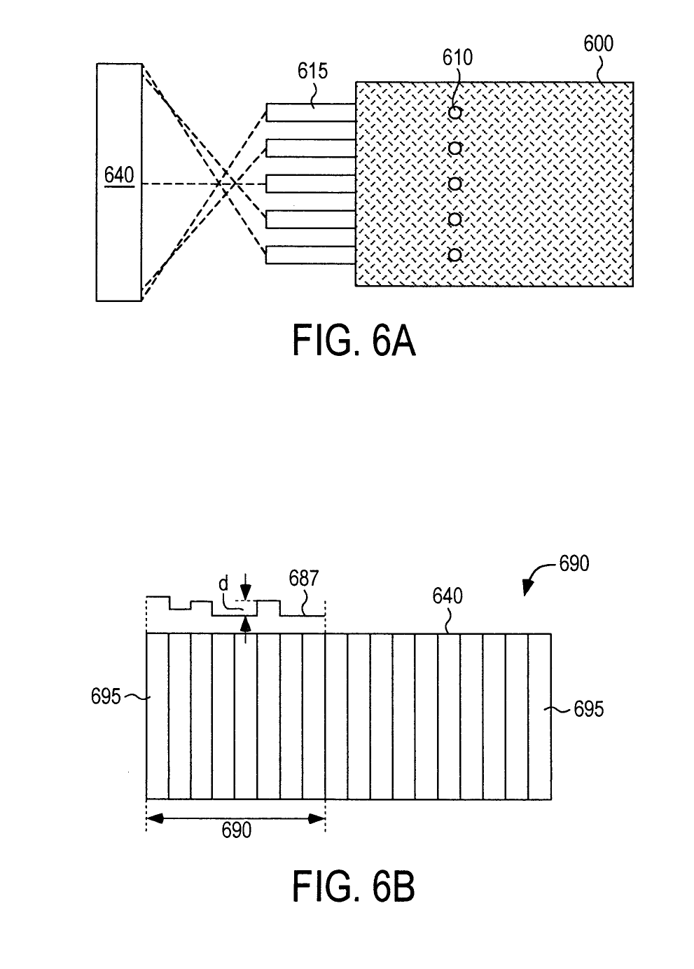

In accordance with an embodiment of the invention, an array of photonic crystal sensors 610 may be arranged on sensor chip 600 as shown in simplified form in FIG. 6a. An array of waveguides 615 can be brought to the edge of sensor chip 600, one waveguide 615 for each photonic crystal sensor 610. The pitch for array of waveguides 615 is typically about 4 μm. The focal length of a high NA focusing lens in accordance with the invention is typically 1 mm and the aperture of the focusing lens is typically 0.5 mm. The number of waveguides 615 that are addressable in the array is effectively limited by how large an angle of incidence can be achieved while maintaining an adequate transmittance into waveguides 615 (see FIGS. 2a and 2b) for a fixed input power.

Array of photonic crystal sensors 610 may be addressed using diffractive array generator 640 to address or couple into array of waveguides 615 simultaneously. Diffractive array generators such as diffractive array generator 640 are described in, for example, Gmitro, A. F. and Coleman, C. L., Optoelectronic Interconnects and Packaging, Proceeding SPIE, v. CR62, 88, 1996 which is incorporated herein by reference. Commercially available diffractive array generators generate 20 diffractive orders and are about 95% efficient. Diffractive array generator 640 is designed to provide a predetermined angular separation between neighboring diffraction orders or beamlets. For example, if the focal length is about 1 mm and the pitch of array of waveguides 615 is 4 μm, the required angular separation is 0.004 radians. Diffractive array generator 640 is typically divided into diffractive supercells 690. The angular separation determines the size of diffractive supercell 690 (see FIG. 6b) which is determined by λ/sin θ where λ is the wavelength of the light and θ is the angular separation. For θ=0.004 and λ=1500 nm, the size of diffractive supercell 690 is about 375 μm. Diffractive supercell 690 is typically divided into a number of pixels 695 where each pixel 695 imparts a phase delay. The phase delay created by each pixel 695 is determined by etching into surface 687 of diffractive supercell 690 a depth d, so that the phase delay is given by (n₁−n₂)2dπ/λ where n₁ is the refractive index of diffractive supercell 690, n₂ is the refractive index of the surrounding medium and λ is the optical wavelength.

The larger the number of pixels 695, the more diffraction orders can be addressed and the better the uniformity of the power across the diffractive orders will be. Taking pixels 695 to have a size of about 1 μm and diffractive supercell 690 to have a size of 375 μm allows diffraction of light into about 100 orders with intensity of each order being equal to within about 20%.

The effect of a tunable optical source needs to be considered as the wavelength is changed. For example, given a tuning range of about 10 nm with a center wavelength of 1500 nm for the tunable optical source, the 50^{th} diffractive order is diffracted at an angle of about 11.57 degrees at 1500 nm and the 50^{th} diffractive order is diffracted at an angle of about 11.62 degrees at 1510 nm. The lateral displacement of the diffraction order is then about 200 μm at 1500 nm and about 201 μm at 1510 nm. While coupling efficiency is reduced, a significant portion is still coupled into waveguide 615 over the 10 nm tuning range of the tunable optical source. A 10 nm tuning range is typically adequate to cover the entire dynamic range of photonic crystal sensors 610 for detecting biomolecule adhesion to photonic crystal sensors 610 in the presence of water. To obtain a wider tuning range, it is typically necessary to reduce the number of diffraction orders and therefore, the number of addressable waveguides 615. Static diffractive elements for diffractive array generator 640 are typically made from dielectric materials such as quartz or polymers such as polymethylmethacrylate or polycarbonate.

Alternatives to diffractive array generators include spatial light modulators (SLM) that can be used as dynamically reconfigurable diffractive array generators, see, for example, Kirk, A. et al. in Optical Communications, vol. 105, 302-308, 1994, and MEMs based dynamically reconfigurable mirror arrays, see, for example, Yamamoto, T et al. in IEEE Photonics Technology Letters, 1360-1362, 2003. SLMs typically allow individual addressing of each of waveguides 615 sequentially in time.

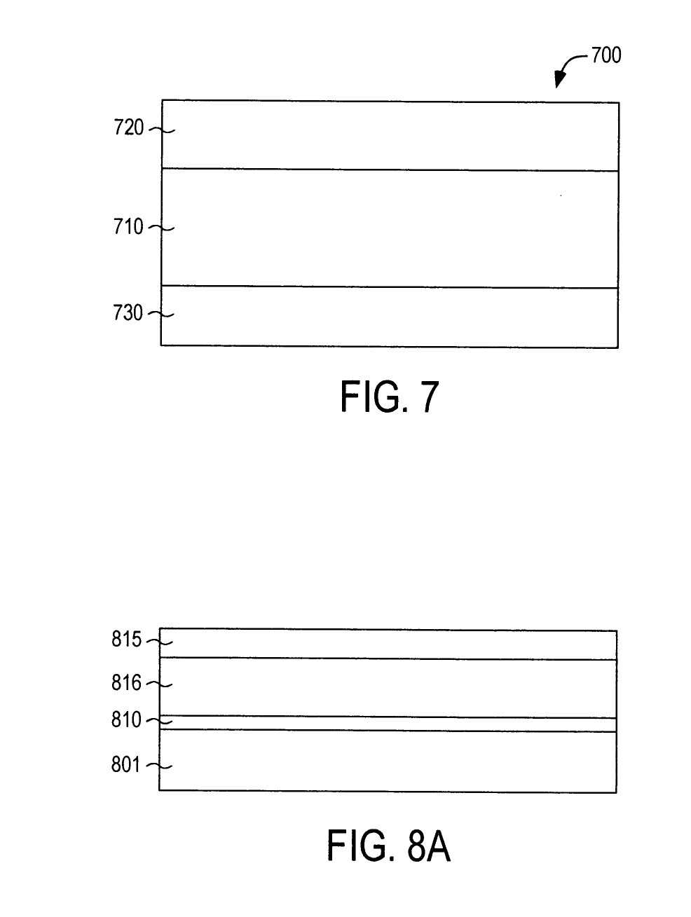

FIG. 7 shows an embodiment in accordance with the invention using materials stack 700. High refractive index core layer 710 with refractive index in the range from 3 to 4, such as Si or Ge single crystalline material or such as GaAs or InP compound semiconductor material, is surrounded by cladding layers 720 and 730. Cladding layers 720 and 730 are typically made from materials having a refractive index of about 1.5 such as SiO₂, Al₂O₃ or spin on glass. When using Si single crystalline material, top and bottom cladding layers 720 and 730 are typically formed from material having a refractive index of about 1.5 such as SiO₂ or spin on glass. When using compound semiconductor material such as III-V material, bottom cladding layer 720 is typically Al₂O₃ (refractive index of about 1.76) due to the ease with which epitaxial layers with aluminum containing compounds may be formed. The aluminum layer is later oxidized using lateral oxidation. If light is to be coupled out of the plane of materials stack 200, upper cladding layer 730 typically has a higher refractive index than lower cladding layer 720 and may be made from SiO₂, Si₃N₄ or other suitable material with a refractive index less than 2.

Typical starting structures for two dimensional photonic crystal sensors in accordance with the invention are silicon on insulator (SOI) wafers, GaAs/AlₓO_{y} or InGaAsP/AlₓO_{y} materials. Two dimensional photonic crystal sensors may be realized, for example, in GaAs/AlₓO_{y} or InGaAsP/AlₓO_{y} materials by using wet oxidation technology developed for vertical cavity surface emitting lasers (VCSELs) and in small refractive index contrast materials such as InGaAsP/InP or GaAs/AlGaAs based materials which require deep etching while preserving vertical sidewalls to reduce propagation losses.

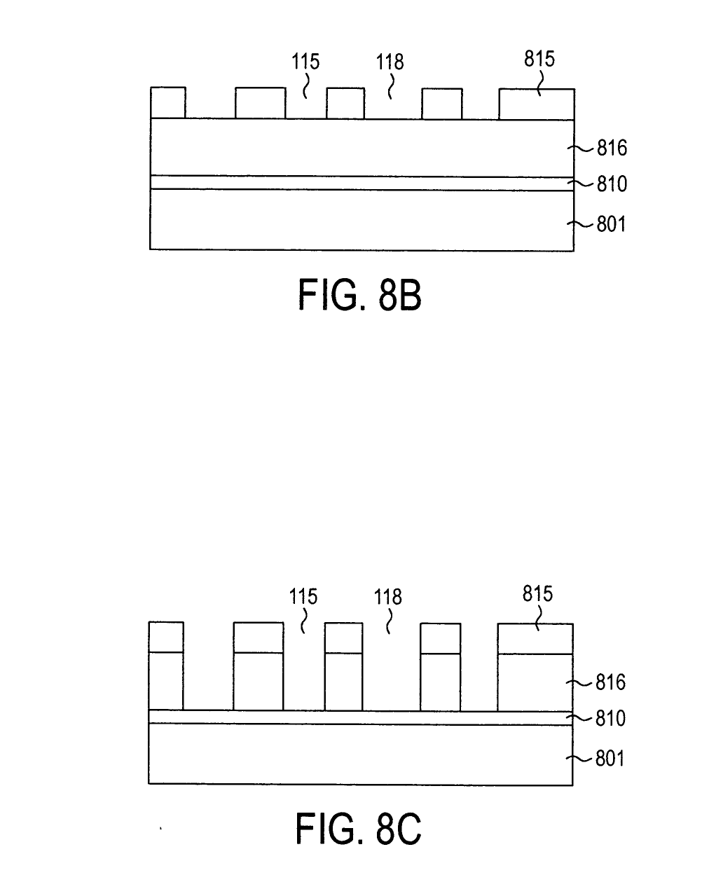

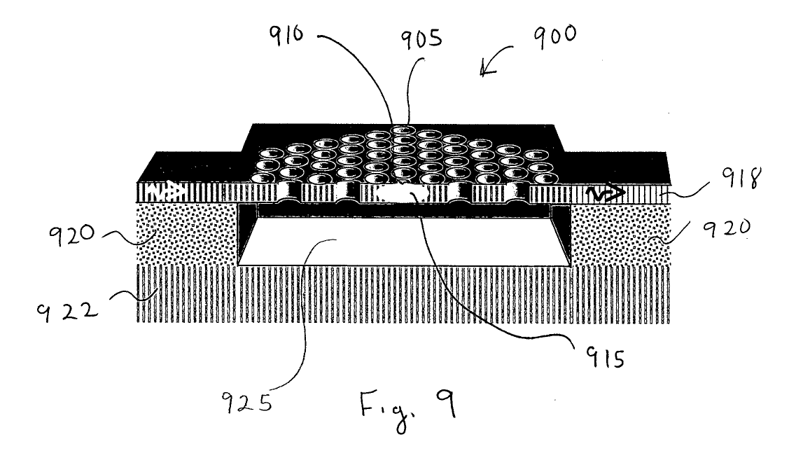

In accordance with an embodiment of the invention and with reference to FIG. 8a, two dimensional photonic crystal sensors are fabricated from SOI wafers with Si slab 801 having a thickness of about 260 nm separated from Si substrate 816 by SiO₂ layer 810 having a thickness of about 1 μm. FIG. 8a shows 100 nm thick SiO₂ hard mask 815 deposited on SOI wafer 810 using low temperature plasma assisted chemical vapor deposition. The thickness of Si slab 816 is selected to provide a large photonic bandgap as described by Johnson, S. G., et al. in Physics Review B, vol. 60, 8, p. 5751, 1999. Thicknesses for Si slab 816 that are greater than about 260 nm are found using the effective index method to result in multimode waveguides. Use of different cladding layers adjusts the thickness of Si slab 816 accordingly.

Photonic crystal lattice structure 110 and ridge waveguides 175 (see FIG. 1) are patterned in a single lithography step using an e-beam lithography tool. Photonic crystal lattice structure 110 is typically defined in high resolution mode on about a 5 nm grid and ridge waveguides 175 are typically defined on a coarser grid of about 50 nm. Alignment between photonic crystal lattice structure 110 and ridge waveguides 175 is maintained by referencing both photonic crystal lattice structure 110 and ridge waveguides 175 to metal alignment marks (not shown) created in a prior lithographic step. Hole 118 is typically surrounded by 2 to 4 lattice periods perpendicular to the direction of propagation in ride waveguides 175. The e-beam lithography pattern is typically transferred into SiO₂ hard mask 815 (see FIG. 8b) with a reactive ion etch (RIE) using a CHF₃/He/O₂ chemistry. Etching of Si slab 816 (see FIG. 8c) is performed using an HBr chemistry to create highly vertical and smooth sidewalls, see Painter et al., Journal of Lightwave Technology, 17 (11) p. 2082, 1999, incorporated herein by reference. To obtain good quality facets on photonic crystal lattice structure 110, top surface 145 of photonic crystal lattice structure 110 is protected by a thermally stable organic medium (typically photoresist) that can be easily removed following deposition when photonic crystal lattice structure 110 is diced and polished. Polishing is typically carried out using a SYTON®, colloidal silica polish.

Appropriate sizes for defect hole 118 and holes 115 are achieved by balancing the layout geometry considerations with the electron beam dose. In dose definition experiments for nanoscale features, proximity effects must be considered. Doses are correlated with the final hole dimension after both the SiO₂ and Si etch processes. The final dimensions of holes 115 and defect hole 118 are typically smaller than the features as defined by e-beam lithography indicating that the etch processes typically yield sidewalls less than vertical.

The particular etch process used to transfer patterns into SiO₂ layer 815 has an effect on the diameter of holes 115 and defect hole 118. Holes 115 and defect hole 118 may either increase or decrease in diameter depending on the particular etch conditions. Lower reactor pressures during the etch process result in a smaller change in the diameter from design dimensions to final dimensions of holes 115 and defect hole 118. Typical fabrication tolerances are less than 2% from the initial lithography pattern to photonic crystal lattice structure 110. Underlying SiO₂ layer 810 is retained to provide additional mechanical support.

In accordance with the invention, single nanoparticle detection may be achieved. Nanoparticles for the purpose of this application are defined as particles such as, for example, molecules, whose effective radius is on the order of 1 to 250 nanometers. The choice of operating wavelength for photonic crystal sensors 303-304, for example, where a thin film is being measured, differs from where a photonic crystal sensor is used to measure a fixed volume such as a single nanoparticle. Typically, the sensitivity of a two dimensional photonic crystal sensor is Δλ/λ (or Δν/ν) and is proportional to the analyte volume divided by the optical mode volume. The optical mode volume is proportional to the operating wavelength cubed (λ³) where the optical mode volume may be defined as that volume which encloses 90% of the optical intensity. In measuring thin films, the analyte volume is proportional to the operating wavelength squared (λ²) so the measured responsivity (Δλ) is proportional to thickness and independent of the operating wavelength. However, for single nanoparticle detection, the analyte volume is fixed. Hence, the measured absolute responsivity, Δλ, is inversely proportional to λ². Therefore, the measured absolute wavelength responsivity Δλ increases as the operating wavelength decreases. Physical obstacles to decreasing the operating wavelength typically include material absorption and the existence of a suitable tunable optical. For example, Si absorbs at wavelengths less than about 1 μm source. The problems may be addressed by changing to materials transparent at wavelengths shorter than about 1 μm such as GaN or GaAs and changing the detection scheme to one of the detection schemes discussed above that do not require a tunable source.

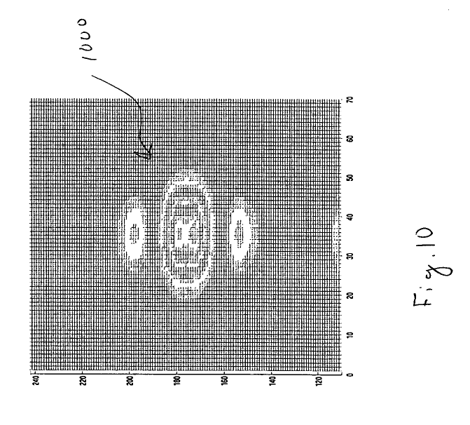

FIG. 9 shows photonic crystal sensor 900 in accordance with the invention to allow single nanoparticle detection. Holes 905 of the same radius are typically etched all the way through photonic crystal slab 918, typically Si, GaN, InP or GaAS or other suitable high refractive index material. Photonic crystal slab 918 is optically coupled to a waveguide (not shown in FIG. 9) for inputting light into photonic crystal sensor 900. Photonic crystal sensor 900 is formed from a two dimensional photonic crystal lattice structure by changing the dimensions of a single hole in an otherwise uniform two dimensional periodic lattice to create defect hole 910. Region 915 shows the effective sensing volume. Optical confinement in the third dimension is typically provided by low refractive index supports 920, typically of SiO₂ and air layer 925 over substrate 922, typically Si. Photonic crystal sensor 900 can be used to measure the presence of nanoparticles in or passing through defect hole 910. In accordance with the invention, the nanoparticles are typically suspended in a carrier liquid such as, for example, water.

The operating frequency of photonic crystal sensor 900 decreases as the effective or average refractive index of the material inside holes 905 and hole 910 increases. The responsivity for photonic crystal sensor 900 is defined as the change in wavelength, with respect to the change in refractive index, Δn. For photonic crystal sensors 900 fabricated using silicon on insulator (SOI) material, the responsivity, Δλ/Δn, typically ranges from about 150 nm to about 300 nm. When the refractive index only changes in defect hole 910, the responsivity, Δλ/Δn, typically ranges from about 75 nm to about 150 nm. Typical dimensions for an embodiment of photonic crystal sensor 900 in accordance with the invention have a lattice constant, a, of about 440 nm, a radius r for holes 905 in the range from about 0.25a to about 0.4a, a radius r′ for defect hole 910 in the range from about 0.15a to about 0.25a and a thickness, t, of about 0.6a for photonic crystal slab 918. A typical volume for defect hole 910 is on the order of 1×10⁻¹⁷ L. or 6×10⁶ nm³. Hence, a 10 nm diameter nanoparticle such as a molecule occupies a fractional volume of about 104. Most common organic molecules such as proteins, antibodies or viruses have a refractive index of about 1.5 while the refractive index of water is about 1.3. Therefore, the presence of a 10 nm molecule in defect hole 910 provides a refractive index change of about 2×10⁻⁵ resulting in a shift in operating wavelength of photonic crystal sensor 900 of about 3 pm. The detection scheme discussed above using a wavelength tunable laser has the required sensitivity.

The design for photonic crystal sensor 900 is typically tuned for single nanoparticle responsivity by varying r/a and r′/a where r and r′ are the radii of holes 905 and defect hole 910, respectively, and a is the lattice constant and by determining the change in operating frequency for refractive index changes only in defect hole 910, normalized to the volume of defect hole 910. As noted above, as the size of holes 905 and defect hole 910 is increased, the operating wavelength increases which is important when the tuning range of the tunable optical source is fixed. To keep the operating wavelength within the fixed tuning range of the optical source requires the lattice constant be adjusted as well. An example of tuning is reducing the radius of defect hole 910 to increase the shift in operating wavelength for sensing at a fixed wavelength. For example, a calculation shows that the measured response in operating wavelength increases by about 50 percent, from Δλ˜0.012 nm to ˜0.018 nm for the radius r′ of defect hole 910 being reduced from about 107 nm to about 67.5 nm when sensing a single nanoparticle having a radius of about 10 nm.

Typical dimensions for biomolecules are about 2 nm to 4 nm for proteins, about 4 nm to 10 nm for antibodies and about 40 nm to 100 nm for viruses. Individual molecules can be delivered to defect hole 910 using microfluidic channels. Microfluidic channels may be fabricated on a variety of materials such as, for example, glass, polydimethyl siloxane (PDMS), polyimide or other photodefinable organics. If desired, photonic crystal sensor 900 can be converted into a membrane structure by removing low refractive index supports 925. Creating a membrane structure may be useful in controlling the flow of the analyte when it is required that the analyte travel into defect hole 910 of photonic crystal sensor 900. Redirecting the flow through the membrane structure rather than above the sensor will enhance the flow of liquid into defect hole 910. The interaction of the analyte with the sensor field is increased but the reduced diameter through which the liquid now flows, slows down the overall flow in the microfluidic channel or requires increased pressure to obtain the same overall flow rate.

In some embodiments in accordance with the invention, the flow through or into holes 905 is blocked, allowing flow through or into defect hole 910. Materials having a refractive index between about 1 and about 1.7 such as polymethylmethacrylate and silicon dioxide can be used to fill holes 905 while still allowing satisfactory performance of photonic crystal sensor 900. The responsivity for embodiments in accordance with the invention of photonic crystal sensor 900 to particles passing through holes 905 is typically at least a factor of two less than the responsivity of photonic crystal sensor 900 to particles passing through defect hole 905. Therefore, only when the concentration of analyte particles is high, is it typically necessary to fill holes 905.

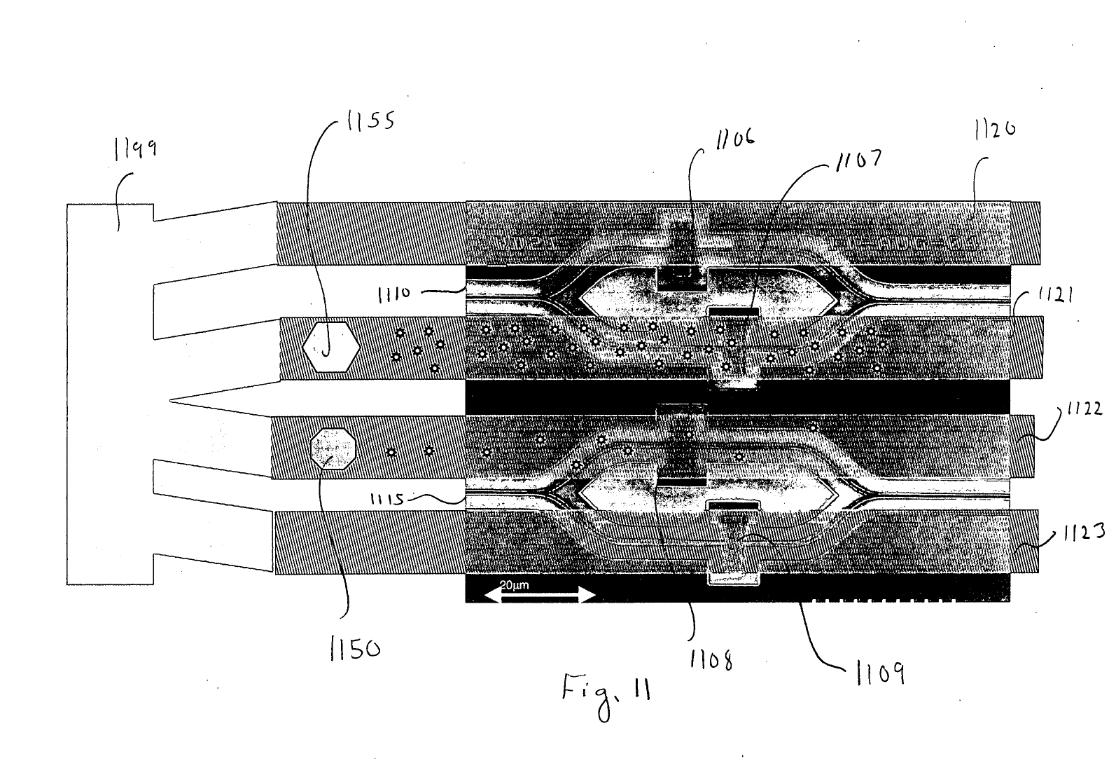

In accordance with the invention, both holes 905 and defect hole 910 may be filled with low refractive index material because the optical field in the vicinity of defect hole 910 extends both below and above photonic crystal slab 918 as shown in FIG. 10. FIG. 10 shows a typical out-of-plane optical field distribution 1000 for λ˜1350 nm in accordance with the invention and is centered about the central axis of defect hole 910. Therefore, the operating frequency of photonic crystal sensor 900 will also change when a particle is placed over defect hole 910. This detection mode typically does not require any label or tag on the analyte because of the refractive index difference between water and the analyte and therefore eases sample preparation effort while, however, decreasing specificity.

Particular molecules may be tagged with a very small particle on the order of about 1 nm to 5 nm in radius of high refractive index material such as, for example, Au or Ag. For details, see for example, J. F. Hainfeld, “Labeling with nanogold and undecagold: techniques and results” in Scanning Microscopy Supplement, 10, 309-325, 1996 and J. F. Hainfeld and R. D. Powell, “New Frontiers in Gold Labeling” in Journal of Histochemistry and Cytochemistry, 48, 471-480, 2000, incorporated herein by reference. Here, photonic crystal sensor 900 responds to the presence of the high refractive index particle acting as a tag to allow detection of the particular molecule that is tagged. Because very small changes in refractive index can be detected in accordance with the invention, many different tags can be used to allow a high degree of multiplexing. Typical high refractive index materials for tags include CdS, InP or metals such as Au or Ag mentioned above.

Small beads from about 30 nm to 100 nm in diameter can be functionalized to allow specific biomolecules to adhere to the bead surface. Typically, the beads are polystyrene latex beads in a water solution. Polystyrene latex beads are typically coated with a CVD (chemical vapor deposition) deposited SiO₂ thin film typically having a thickness of on the order of about 10 A to 50 A. This coating is typically followed by a CVD deposited hydrophobic silane compound such as, for example, fluorodecyltrichorosilane (FDTS) or decyltrichlorosilane (C-10). A bead surface may typically be functionalized with, for example, a protein, a biotinlated protein or an antibody. If the bead surface is functionalized with a protein, binding occurs with the antibody for the specific protein. If the bead surface is functionalized with an antibody, binding occurs with the protein for the specific antibody. If the bead surface is functionalized with a biotinlated protein, antibody binding occurs with the biotin on the surface of the protein. An antibody for a specific protein may be immobilized on the resulting hydrophobic surface enabling specific binding information for a specific bead size. With good control of the bead size, the number of biomolecules bound to the bead surface can be measured as a bead passes through defect hole 910 of photonic crystal sensor 900. The change in operating wavelength, Δλ or frequency, Δν is proportional to the fractional change in the volume or refractive index of defect hole 910: Δλ˜αρ³ where α incorporates the responsivity of the sensor and ρ is the radius of the sphere. This gives a responsivity to the bead radius of Δλ/Δρ˜3αρ². For example, given a 50 nm diameter bead, the change in operating wavelength with respect to the change in radius due to the adhesion of the biomolecules is Δλ/Δρ˜0.23 so that every 1 nm shift in radius corresponds to a shift in operating wavelength of 0.23 nm. A solution containing different size beads may be functionalized with a different chemistry to perform several different binding experiments in solution and then analyze the binding coefficient by passing the beads through defect hole 910 of photonic crystal sensor 900.

FIG. 11 shows an embodiment in accordance with the invention where photonic crystal sensors 1106, 1107, 1108 and 1109 are integrated on single substrate 1104 to allow differential measurements. Note that the photonic crystal lattice is not necessarily identical for photonic crystal sensors 1106, 1107, 1108 and 1109. Optical waveguide 1110 allows optical interrogation of both photonic crystal sensors 1106 and 1107, respectively while optical waveguide 1115 allows optical interrogation of both photonic crystal sensors 1108 and 1109, respectively. Microfluidic channels 1120, 1121, 1121 and 1123 (shown schematically) deliver fluidic components to photonic crystal sensors 1106, 1107, 1108 and 1109, respectively. Located upstream in microfluidic channels 1121 and 1122 from photonic crystal sensors 1107 and 1108, respectively, are structures 1155 and 1150 for creating an analyte or interacting with a desired analyte. For example, if structures 1150 and 1155 are normal and abnormal cells, respectively, the cells are incubated and immobilized on the chip, see for example, H. Andersson and A. Van den Berg, “Microfabrication and microfluidics for tissue engineering: state of the art and future opportunities”, Lab on a Chip, 4, 98-103, 2004, incorporated herein by reference. Microfluidic channels 1120 and 1123 along with photonic crystal sensors 1106 and 1109, respectively, provide reference signals to allow compensation for temperature fluctuations, and buffers and solvents etc. in the carrier fluid. External microfluidic input port 1199 is used to insert drugs, water, nutrients for the cells and a corresponding output port (not shown) downstream from photonic crystal sensors 1106, 1107, 1108 and 1109 is used to collect excess fluid. Photonic crystal sensors 1106, 1107, 1108 and 1109 may be used, for example, to measure drug consumption of cells or to measure the change in proteins excreted from the cells in the presence of drugs or other molecules.

1. A two dimensional photonic crystal sensor apparatus for detecting single nanoparticles comprising:
a waveguide for inputting light; and
a photonic crystal slab optically coupled to said waveguide, said photonic crystal slab being pierced through by a two dimensional periodic lattice of holes, said two dimensional periodic lattice of holes comprising a lattice constant and a defect hole tuned for detecting said single nanoparticles, said photonic crystal slab operable to receive said light from said waveguide and operable to confine said light in said defect hole at an operating wavelength.

2. The apparatus of claim 1 wherein said two dimensional periodic lattice of holes except for said defect hole is filled with a low refractive index material.

3. The apparatus of claim 2 wherein said defect hole is filled with said low refractive index material.

4. The apparatus of claim 3 wherein a carrier liquid comprising said single nanoparticles is flowed over said defect hole.

5. The appaaratus of claim 4 wherein said carrier liquid is flowed to said defect hole using microfluidic channels on said photonic crystal slab.

6. The apparatus of claim 1 wherein a carrier liquid comprising said single nanoparticles is passed through said defect hole.

7. The apparatus of claim 6 wherein said carrier liquid is flowed to said defect hole using microfluidic channels on said photonic crystal slab.

8. The apparatus of claim 1 wherein said waveguide is a conventional ridge waveguide.

9. The apparatus of claim 1 wherein said single nanoparticles are tagged with high refractive index particles.

10. The apparatus of claim 9 wherein multiplexing is used to detect said tagged single nanoparticles.

11. The apparatus of claim 1 said single nanoparticles are functionalized beads.

12. The apparatus of claim 11 wherein said beads are comprised of polystyrene latex.

13. The apparatus of claim 11 wherein said beads are functionalized with a protein.

14. The apparatus of claim 11 wherein said beads are functionalized with an antibody.

15. The apparatus of claim 11 wherein said beads are functionalized with a biotinlated protein.

16. The apparatus of claim 1 wherein said photonic crystal slab is a membrane.

17. A system for differential measurement of single nanoparticles comprising
a first and a second photonic crystal sensor apparatus as said photonic crystal sensor apparatus in claim 1, said first and said second photonic crystal sensor apparatus on a single substrate; and
a first and a second microfluidic channel fluidly coupled to said first and second photonic crystal sensor apparatus, respectively, to deliver fluidic components to said first and second photonic crystal sensor apparatus.

18. The system as in claim 17 further comprising a third and fourth photonic crystal sensor apparatus on said single substrate; and
a third and fourth microfluidic channel fluidly coupled to said third and fourth photonic crystal sensor apparatus, respectively, to deliver fluidic components to said third and said fourth photonic crystal sensor apparatus.

19. The system of claim 18 wherein a second structure and a third structure are located upstream from said second and third photonic crystal sensor apparatus in said second and said third microfluidic channels, respectively.

20. The system of claim 19 wherein said second and said third structures are for interacting with an analyte.

21. The system of claim 19 wherein said second structure is a normal cell and said third structure is an abnormal cell.
